(19) United States
(12) Patent Application Publication
(10) Pub. No.: US 2026/0106457 A1
(43) Pub. Date: Apr. 16, 2026

(54) SYSTEMS, APPARATUSES, METHODS, AND COMPUTER PROGRAM PRODUCTS FOR DYNAMIC ENERGY LOAD MANAGEMENT

(71) Applicant: Honeywell International Inc., Charlotte, NC (US)

(72) Inventors: Jayalaxmi Vaman Telang, Bangalore (IN); Karthika Murugesan, Bangalore (IN)

(21) Appl. No.: 18/916,162

(22) Filed: Oct. 15, 2024

(51) Int. Cl. H02J 3/00

(52) U.S. Cl. CPC H02J 3/004; H02J 2103/35

(57) ABSTRACT

Embodiments of the present disclosure relate to load optimization. At least one asset of a set of assets associated with a building may be identified. Dynamic asset classification for the at least one asset may be generated for an optimization period by applying input data associated with the at least one asset to an asset classification machine learning model. Deviation data may be generated for the at least one asset in response to a non-critical classification for the at least one asset by applying a dataset comprising current operating load data for the at least one asset and current environmental condition data to an optimization machine learning model configured to compare the current operating load data for the at least one asset to operating load range for the at least one asset. Optimization data may be generated for the at least one asset based on the deviation data.

### TECHNICAL FIELD

The present disclosure relates, generally, to load management. Example embodiments provide systems, apparatuses, methods, and computer program products for dynamic energy load management.

### BACKGROUND

Applicant has discovered problems with current implementations of load management. Through applied effort, ingenuity, and innovation, Applicant has solved many of these identified problems by developing solutions embodied in the present disclosure, which are described in detail below.

### BRIEF SUMMARY

In accordance with one aspect of the present disclosure, a computer-implemented method is provided. The computer-implemented method is executable utilizing any of a myriad of computing device(s) and/or combinations of hardware, software, and/or firmware. In some example embodiments, an example computer-implemented method comprises identifying, by one or more processors, at least one asset of a set of assets associated with a building; generating, by the one or more processors, dynamic asset classification for the at least one asset for an optimization period by applying input data associated with the at least one asset to an asset classification machine learning model configured to perform classification operation task on the input data, wherein the input data comprises one or more asset classification variables; generating, by the one or more processors, in response to a non-critical classification for the at least one asset, deviation data for the at least one asset by applying a dataset comprising current operating load data for the at least one asset and current environmental condition data to an optimization machine learning model configured to compare the current operating load data for the at least one asset to operating load range for the at least one asset; generating, by the one or more processors, optimization data for the at least one asset based on the deviation data; and initiating, by the one or more processors, performance of one or more load optimization-based actions based on the optimization data.

In some embodiments, the dataset further comprises one or more operating load guidelines, wherein the operating load range for the at least one asset is determined based on the current environmental condition data.

In some embodiments, the at least one asset is associated with a spatial region of one or more spatial regions associated with the building, wherein the operating load range is further determined based on spatial region type of the spatial region associated with the at least one asset.

In some embodiments, the computer-implemented method further comprises receiving a spatial model associated with the building; and generating spatial region data for the spatial model by applying the spatial model and building ontology data to a spatial region classification machine learning model configured to perform analytics on the spatial model using the building ontology data.

In some embodiments, the one or more asset classification variables comprise one or more of environmental condition, spatial region occupancy, or spatial region activity.

In some embodiments, the current operating load data comprises temperature set point.

In some embodiments, initiating the performance of the one or more optimization-based actions comprises transmitting computer-executable instructions configured to cause modification of one or more parameters of the asset such that the current operating load data is within the operating load range.

In accordance with another aspect of the present disclosure, an apparatus is provided. The apparatus in some embodiments includes at least one processor and at least one non-transitory memory, the at least one non-transitory memory having computer-coded instructions stored thereon. The computer-coded instructions in execution with the at least one processor causes the apparatus to perform any of the example computer-implemented methods described herein. In some other embodiments, the apparatus includes means for performing each step of any of the computer-implemented methods described herein.

In accordance with another aspect of the present disclosure, a computer program product is provided. The computer program product in some embodiments includes at least one non-transitory computer-readable storage medium having computer program code stored thereon. The computer program code in execution with at least one processor is configured for performing any one or the example computer-implemented methods described herein.

### BRIEF DESCRIPTION OF THE SEVERAL VIEWS OF THE DRAWINGS

Having thus described the embodiments of the disclosure in general terms, reference now will be made to the accompanying drawings, which are not necessarily drawn to scale, and wherein:

FIG. 1 illustrates a block diagram of an example system architecture in which embodiments of the present disclosure may operate.

FIG. 2 illustrates a block diagram of an example apparatus in accordance with at least one example embodiment of the present disclosure.

FIG. 3A illustrates a data flow diagram showing example data structures for classifying assets for optimization in accordance with at least one example embodiment of the present disclosure.

FIG. 3B illustrates is a data flow diagram showing example data structures for load optimization in accordance with at least one example embodiment of the present disclosure.

FIG. 4 illustrates a flowchart including operations of an example process for asset classification for optimization in accordance with at least one example embodiment of the present disclosure.

FIG. 5 illustrates a flowchart including operations of an example process for load optimization in accordance with at least one example embodiment of the present disclosure.

### DETAILED DESCRIPTION

Various embodiments of the present disclosure now will be described more fully hereinafter with reference to the accompanying drawings, in which some, but not all, embodiments of the present disclosure are shown. Indeed, the present disclosure may be embodied in many different forms and should not be construed as limited to the embodiments set forth herein, rather, these embodiments are provided so that this disclosure will satisfy applicable legal requirements.

The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not indicate being based only on or based solely on the referenced element or elements unless so indicated. Like numbers refer to like elements throughout.

### OVERVIEW AND TECHNICAL IMPROVEMENTS

Various embodiments of the present disclosure are generally directed to systems, apparatuses, methods, and computer program products for dynamic energy load management.

Sudden increase in building demand pushes power prices and emissions to record levels, with serious implications managing energy demand needs for consumers and economies. In many regions building owners may incur significantly high charges based on sudden peak demand needs at their site.

Example embodiments provide techniques for maintaining energy demand for a site below a predetermined threshold by selecting one or more assets from the set of assets associated with the site for optimization based on dynamic classification of the set of assets, and optimizing the load (e.g., corresponding to energy consumption) associated with the site by analyzing the selected assets and adjusting operating load parameter(s) for one or more of the selected assets.

The inventors have observed that classification for an asset is not static in that an asset may be critical during certain time interval and/or under certain conditions and may not be critical during another time and/or under certain conditions. In this regard, example embodiments automatically assess the classification for the set of assets periodically (e.g., every 15 minutes, every hour, weekly, and/or the like) based on asset classification variables and classify or re-classify one or more assets based on one or more asset classification variables. Example embodiments, identify candidate assets from the assets classified as non-critical assets.

Example embodiments optimize identified candidate assets such that the load associated with the optimized candidate assets are reduced to maintain the energy demand by the site within the predetermined threshold. In this regard, example embodiments provide various technical advantages and improve various technical fields and technologies including the technical field of energy consumption management and energy monitoring and/or management systems.

### DEFINITIONS

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

As used herein, the terms “data,” “content,” “digital content,” “information,” and similar terms may be used interchangeably to refer to data capable of being transmitted, received, and/or stored in accordance with embodiments of the present disclosure. Further, where a computing entity is described herein to receive data from another computing entity, it will be appreciated that the data may be received directly from another computing entity or may be received indirectly via one or more intermediary computing entities, such as, for example, one or more servers, relays, routers, network access points, base stations, hosts, and/or the like, sometimes referred to herein as a “network.” Similarly, where a computing entity is described herein to send data to another computing device, it will be appreciated that the data may be sent directly to another computing entity or may be sent indirectly via one or more intermediary computing devices, such as, for example, one or more servers, relays, routers, network access points, base stations, hosts, and/or the like.

### EXAMPLE SYSTEMS AND APPARATUSES OF THE DISCLOSURE

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

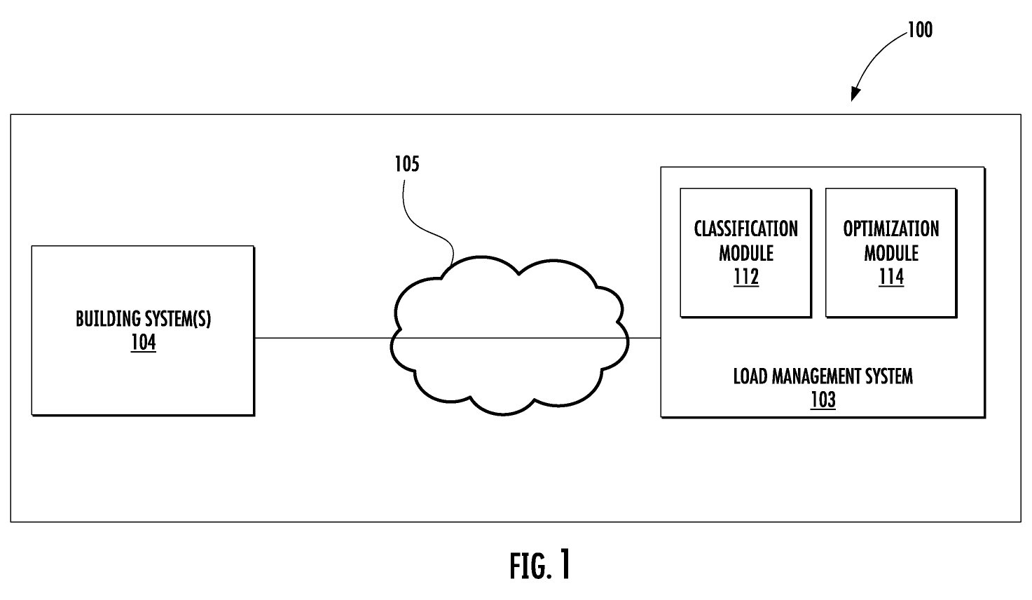

In this regard, FIG. 1 provides an example overview of a system architecture 100 in accordance with at least some example embodiments of the present disclosure. The depiction of the example architecture 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1 and the architecture 100 disclosed therein is merely presented to provide an example basis and context for the facilitation of some of the features, aspects, and uses of the methods, apparatuses, computer readable media, and computer program products disclosed and contemplated herein. It will be understood that while many of the aspects and components presented in FIG. 1 are shown as discrete, separate elements, other configurations may be used in connection with the methods, apparatuses, computer readable media, and computer programs described herein, including configurations that combine, omit, separate, and/or add aspects and/or components. The example system architecture 100 may be used in a plurality of domains and not limited to any specific application as disclosed herewith. In particular, while some example embodiments are described herein with reference to industrial plant domain, the example system architecture 100 may be used in a plurality of domains and limited to any specific application as disclosed herein. The plurality of domains may include healthcare, industrial, manufacturing, education, retail, to name a few.

As illustrated, the system architecture 100 includes a load management system 103 in communication with one or more building systems 104. In some embodiments, the load management system 103 communicates with the building system 104 over one or more communications network(s), for example a communications network 105.

It should be appreciated that the communications network 105 in some embodiments is embodied in any of a myriad of network configurations. In some embodiments, the communications network 105 embodies a public network (e.g., the Internet). In some embodiments, the communications network 105 embodies a private network (e.g., an internal localized, or closed-off network between particular devices). In some other embodiments, the communications network 105 embodies a hybrid network (e.g., a network enabling internal communications between particular connected devices and external communications with other devices). The communications network 105 in some embodiments includes one or more base station(s), relay(s), router(s), switch(es), cell tower(s), communications cable(s) and/or associated routing station(s), and/or the like. In some embodiments, the communications network 105 includes one or more user-controlled computing device(s) (e.g., a user owned router and/or modem) and/or one or more external utility devices (e.g., Internet service provider communication tower(s) and/or other device(s)).

Each of the components of the system architecture 100 may be communicatively coupled to transmit data to and/or receive data from one another over the same or different wireless and/or wired networks embodying the communications network 105. Such configuration(s) include, without limitation, a wired or wireless Personal Area Network (PAN), Local Area Network (LAN), Metropolitan Area Network (MAN), Wide Area Network (WAN), and/or the like. Additionally, while FIG. 1 illustrate certain system entities as separate, standalone entities communicating over the communications network 105, the various embodiments are not limited to this architecture. In other embodiments, one or more computing entities share one or more components, hardware, and/or the like, or otherwise are embodied by a single computing device such that connection(s) between the computing entities are over the communications network 105 are altered and/or rendered unnecessary. For example, in some embodiments, a building system 104 may include some or all of the load management system 103, such that an external communications network 105 is not required.

In some embodiments, the one or more building systems 104 (or portion thereof) and the load management system 103 are embodied in an on-premises system within or associated with a building. In some such embodiments, the one or more building systems 104 (or portion thereof) and the load management system 103 are communicatively coupled via at least one wired connection. Alternatively or additionally, in some embodiments, the one or more building systems 104 embodies or includes the load management system 103 (or portion thereof), for example as a software component.

In some embodiments, the one or more building systems 104 is associated with a site. In particular, the one or more building systems 104 may be configured to serve a site. For example, the one or more building systems 104 may be configured to provide one or more functionalities and/or services for a site, such as heating, cooling, lighting, security, and/or the like, Non-limiting examples of a building system 104 include heating, ventilation and Air Conditions (HVAC) systems, lighting systems, security systems, and/or the like. By way of example, the one or more building systems 104 may include one or more of HVAC system(s), lighting system(s), security system(s) and/or other system(s). It would be appreciated that the one or more building systems may include any number of different combinations of building systems which may include or omit the example building system describe above.

In some embodiments, a site represents or otherwise describes a collection of one or more buildings. Such one or more buildings may, for example, be co-located within a geographical area. Non-limiting examples of a site include an industrial site comprising one or more industrial plants; a commercial site such as a shopping mall comprising one or more retail stores; a healthcare site comprising one or more healthcare facilities (e.g., hospitals, emergency centers, labs, and/or the like); and/or the like. In this regard, in some embodiments, the one or more building systems 104 may be associated with one or more buildings. For example, a building system from the one or more building systems 104 may be associated with a single building in that the building system may be configured to serve only the one building. Alternatively or additionally, a building system from the one or more building system 104 may be associated with multiple buildings in that the building system may be configured to serve multiple buildings.

A building system 104 may include one or more equipment and/or other components configured to, individually and/or collectively, facilitate, perform, and/or provide one or more functionalities associated with the building system 104. Non-limiting examples of such equipment and/or other components include HVAC equipment such as chillers, boilers, and/or the like; lighting equipment, security equipment and/or the like. For example, an HVAC system configured to provide heating and cooling in a building may include HVAC equipment such as chillers, boilers, and/or the like configured to support such heating and cooling functionalities provided by the HVAC system. As another example, a lighting system configured to provide lighting for a building may include lighting equipment such as light fixtures, dimmers, and/or the like configured to support such light functionalities provided by lighting system.

In some embodiments, to provide the functionalities associated with each building system of the one or more building systems 104, the component(s) (e.g., equipment and/or other components) of a respective building system 104 (e.g., configured to support the functionalities provided by the respective building system 104) and/or the respective building system 104 consumes energy. Such components of a building system 104 and/or the building system 104 comprising such components may be referred to herein as assets. In this regard, the one or more building systems 104 may define or otherwise is associated with a set of assets that consume energy. Further, an asset may be an equipment and/or system that consumes energy.

As further described below, in some embodiments, the amount of energy consumed by an asset depends at least in part on one or more asset classification variables. In some embodiments, an asset classification variable represents or comprise a feature that affects the amount of energy demand by an asset (e.g., amount of energy consumed by an asset). Example of such features include environmental condition, such as temperature, humidity, and/or the like; occupancy (e.g., expected traffic or actual traffic in a spatial region served by an asset such as, for example, number of people occupying a spatial region or moving in and out of a spatial region); temporal feature (e.g., time of the day, season, and/or the like), activity (e.g., designated activity in a spatial region served by an asset), item type (e.g., types of items in a spatial region served by an asset), and/or asset type.

For example, in some embodiments, the one or more asset classification variables may comprise environmental condition; occupancy; temporal feature, item type, asset type, and/or other features that may affect the amount of energy demand by an asset. It would be appreciated that in some embodiments, the one or more asset classification variables may include other features and/or omit one or more of the above example features.

In some embodiments, the one or more building systems 104 may be located within a single building or distributed across multiple buildings. Alternatively or additionally, in some embodiments, the one or more components of a single building system 104 may be located with a single building or distributed across multiple buildings.

In some embodiments, the one or more building systems 104 may include one or more controllers configured for regulating the functionalities (e.g., heating, cooling, light, security monitoring, and/or the like) provided by the one or more building systems 104. In some embodiments, the load management system 103 may be configured to communicate with the building systems 104 (e.g., via controller(s) associated therewith) to modify one or more operating parameters associated with the one or more building systems 104 and/or associated with one or more components of the one or more building systems 104. In this regard, in some embodiments, the load management system 103 may be configured to function at least in part as a building system controller configured to control one or more aspects of the one or more building systems 104 and/or components of the one or more building systems 104.

The load management system 103 may include any number of computing devices and/or systems configured to control one or more functionalities provided by the one or more building systems 104 in accordance with techniques described herein such that the load demand associated with a building or site served by the one or more building systems 104 is below a predetermined threshold. In some embodiments, the load demand represents energy consumption demand by the set of assets defined by the one or more building systems 104 associated with a building or a site, as described above. In particular, the load management system 103 may be configured to monitor one or more operational parameters of the building systems 104 to maintain the amount of energy consumed by the building under a predetermined threshold at any given instance (e.g., maintain peak energy demand under a predetermined threshold such that occurrence of sudden energy demand spike is prevented).

In some embodiments, the load management system 103 is configured to maintain the energy demand for a site by selecting one or more assets from the set of assets associated with the site for optimization based on dynamic classification of the set of assets, and optimizing the load (e.g., corresponding to energy consumption) associated with the site by analyzing the selected assets and adjusting the operating load parameter(s) for one or more of the selected assets. In some embodiments, adjusting the operating load parameter associated with an asset comprises causing the operating load parameter for the asset to be within a corresponding predetermined operating range. In some embodiments, such predetermined operating range may be industry standard and/or domain standard.

In some embodiments, the load management system 103 is configured to automatically assess the classification for the set of assets periodically (e.g., every 15 minutes, every hour, weekly, and/or the like) based on the asset classification variables and re-classify one or more assets based on the current asset classification variables. For example, the load management system may be configured to periodically analyze input data comprising the asset classification variables with respect to an asset and classify the asset based on the analyzing. In particular, in some embodiments, the load management system 103 is configured to identify input data comprising one more item of data representative and/or indicative of the current dynamic energy variables for the set of assets (or portion thereof) and re-classify one or more assets based on the input data.

In some embodiments, the load management system 103 is configured to classify each asset as critical or non-critical. In some embodiments, the load management system 103 is configured to perform analytics on the input data associated with assets classified as non-critical to identify candidate assets for optimization.

In some embodiments, the load management system 103 is configured to optimize the identified candidate assets such that the load associated with the optimized candidate assets are reduced to, for example, maintain the energy demand by the site within the predetermined threshold.

In some embodiments, the load management system 103 includes an asset classification module 112 and/or a load optimization module 114 configured to support (e.g., via hardware, software, firmware, and/or combination thereof) the functionalities provided by the load management system 103. Each of the asset classification module 112 and the load optimization module 114 may comprise hardware, software, firmware, and/or combination thereof, configured to perform functionalities associated with the respective module, including one or more operations associated with load management (e.g., maintaining the load associated with a site under a predetermined threshold).

In some embodiments, the asset classification module 112 (referred to herein interchangeably as classification module 112) is configured to support dynamic classification of the set of assets associated with a site.

In some embodiments, the asset classification module 112 is configured to receive building data associated with a site. As described above, a site may comprise a single building or may comprise multiple buildings. In this regard, in some examples, the building data may comprise building data for a single building and in some examples, the building data may comprise building data for multiple buildings.

In some embodiments, the building data is received during an onboarding phase. In some embodiments, the building data comprises one or more items of data representative and/or indicative of identifying data for the set of assets, asset type, initial classification for an asset and/or other data about and/or related to the set of assets. In some embodiments, the initial classification for an asset may be user-defined classification for the asset.

In some embodiments, identifying data may comprise asset identifier for each asset or group of assets. In some embodiments, an asset identifier is one or more items or elements by which an asset may be uniquely identified from other assets or by which a group of assets may be uniquely identified from other assets (or other asset groups). An asset identifier may be in the form of text string(s), numerical character(s), alphabetical character(s), alphanumeric code(s), American Standard Code for information Interchange (ASCII) characters(s), and/or the like.

In some embodiments, the asset classification module 112 is configured to generate a classification for the assets periodically (e.g., each optimization period). In particular, in some embodiments, the load management system 103 is configured to classify each asset in the set of assets associated with the site as critical or non-critical based on input data comprising asset classification variables (as described above). In particular, in various embodiments, the classification for an asset is not static in that an asset may be considered critical during certain time interval and/or under certain conditions and may be considered non-critical during another time and/or under certain conditions. In some embodiments, the asset classification variables represent those time intervals and/or certain conditions. In some embodiments, optimization period represents a time period with respect to which the load management system 103 performs asset classification and/or optimization in accordance with techniques described herein.

In some embodiments, the asset classification module 112 leverages an asset classification machine learning model to classify the assets. For a given optimization period, the asset classification module 112 may be configured to apply the input data (e.g., asset classification variables data) for the given optimization period to an asset classification machine learning model configured to assess and/or analyze the asset classification variables data with respect to each asset of the set of assets (or portion thereof) and classify the assets as critical or non-critical based on the analysis. In some embodiments, applying the input data to the asset classification machine learning model comprises inputting the input data into the asset classification machine learning model and obtaining the output (e.g., classification data for the set of assets) of the asset classification machine learning model.

Alternatively or additionally, in some embodiments, the asset classification module 112 is configured to receive spatial model associated with a building. In some embodiments, a spatial model is configured to define spatial regions associated with a building, where a spatial region describes a particular area or space within a building or the vicinity of building. Non-limiting examples of a spatial region includes bathroom, parking area, parking corridor, data center room, server room, cafeteria, physician office, and/or other spaces within and/or associated with a building. In some embodiments, a space model may comprise a representation of a layout of a building.

In some embodiments, the asset classification module 112 is configured to leverage the received spatial model to generate spatial region data for the set of assets. In some embodiments, the asset classification module 112 is configured to apply the spatial model to a spatial region classification machine learning model configured to perform analytics on the spatial model to extract spatial region information from the spatial model and generate spatial region data as described herein. In some examples, the spatial model received by the asset classification module 112 may describe spaces associated with a building using non-standard conventional naming conventions and/or client-specific keywords. In this regard, in some embodiments, the asset classification module 112 may leverage building ontology data to generate spatial region data. In some embodiments, building ontology data comprises one or more items of data representative and/or indicative of a building taxonomy for various building types. For example, in some embodiments, building ontology data may comprise one or more items data that describes the spatial regions (e.g., spaces) associated with various types of buildings (e.g., industrial building, retail building, office building, and/or the like) and subcategories. For example, building ontology data may describe a commercial building as including meeting rooms, conference rooms, work areas, washrooms, parking areas, parking corridors, and/or the like. Alternatively or additionally, in some embodiments, building ontology data may describe a topology of a building type and/or relationships between and among the difference spatial regions (e.g., spaces) associated with a building type.

The asset classification module 112 may be configured to provide the spatial model and building ontology data as input to a spatial region classification model (e.g., spatial region classification machine learning model) configured to perform analytics on the spatial model with the aid of the information provided by input building ontology data to extract spatial region information (e.g., space information) for the building whose spatial model is input into the spatial region classification machine learning model. In some embodiments, such analytics performed by the spatial region classification machine learning model may include textual-based analytics and/or mapping to extract the spatial region information for the building from the spatial model. In some embodiments, the spatial region data output by the spatial region classification machine learning model comprises one or more items of data that describes spatial regions associated with a building and/or the relationship between the spatial regions.

Alternatively or additionally, in some embodiments, the spatial region data output by the spatial region classification machine learning model comprises spatial region classifications for the identified spatial regions. For example, in some embodiments, the spatial region data may comprise one or more items of data representative and/or indicative of a classification for a spatial region. In some embodiments, the classification is selected from a classification space comprising critical classification or non-critical classification. For example, each spatial region may be classified as either critical or non-critical. In some embodiments, the spatial region classifications may be dynamic in that classification for a given spatial region may vary based on the time of day, season, and/or other variables. For example, a particular spatial region may be classified as critical for a first time interval and/or under first conditions (e.g., particular season, weather condition, and/or the like) and classified as a non-critical classification for a second time interval and/or under second.

Alternatively or additionally, in some embodiments, the spatial region data comprises one or more spatial region groups, where each spatial region group is associated with a spatial region group classification. In some embodiments, the one or more spatial region groups comprise at least one spatial region group associated with a critical classification and at least one spatial region group associated with a non-critical classification. In some embodiments, the spatial regions groups may comprise a plurality of spatial region group sets, each spatial region group set comprising at least one spatial region group associated with a critical classification and at least one spatial region group associated with a non-critical classification. In some embodiments, each spatial region group set may be associated with a time interval and/or condition as described above.

Alternatively or additionally, in some embodiments, the identified spatial regions are ranked in order based on a critical level assigned or otherwise associated with the spatial regions. For example, the spatial region data may comprise data representative and/or indicative of an ordered list of spatial regions associated with a building based on a critical level assigned or otherwise associated with the spatial regions. Additionally, in some embodiments, the ordered list may be dynamic in that the order may depend on certain variables which may include the asset classification variables described above (or portion thereof). For example, in some embodiments, the spatial region data may comprise a plurality of ordered lists of spatial regions each associated with a particular time interval and/or condition.

For example, the critical level of the spatial regions may depend on the temporal data such as the time of day and/or season (e.g., fall, summer, winter, autumn, spring, dry season, wet season, and/or the like). By way of example, the asset classification module 112 may assign a cafeteria in a building a first critical level for a first time interval and assigned a parking area associated with the building a second critical level for the first time interval, wherein the first critical level is greater than the second critical level and the occupancy (e.g., the expected and/or actual number of people occupying and/or moving in and out of the space defined by the spatial region relative) of the cafeteria is greater than the expected occupancy for the parking area at the first time interval. Continuing with the example, the asset classification module 112 may assign the cafeteria a first critical level for a second time interval and assigned a parking area associated with the building a second critical level for the second time interval, wherein the first critical level is less than the second critical level and the occupancy for the cafeteria is less than the expected occupancy for the parking area at the second time interval. In this regard, the order of the spatial regions may be based at least in part on temporal data and/or occupancy in the above example. It would be appreciated that the order may be based on any of a number of asset classification variables.

In some embodiments, the classification module 112 is configured to leverage the spatial region data to classify an asset as critical or non-critical. For example, the classification module 112 may be configured to identify the spatial region which an asset serves and classify the asset based on the classification and/or critical level for the identified spatial region for the given optimization period.

In some embodiments, the load optimization module 114 is configured (e.g., via hardware, software, firmware, and/or combination thereof) to perform periodic load optimization to ensure energy consumption demand is below a predetermined threshold.

In some embodiments, the load optimization module 114 (referred to herein interchangeably as optimization module or asset optimization module) is configured, for each optimization period, to identify one or more candidate assets for optimization from the assets classified as non-critical by the classification module 112. For example, a subset of the set of assets may be classified as non-critical for a given optimization period. An asset classified as a critical for a given optimization period may be referred to as a critical asset for the given optimization period and an asset classified as non-critical for a given optimization period may be classified as non-critical for the given optimization period.

In some embodiments, the load optimization module 114 is configured to, for a given optimization period, identify one or more candidate assets by analyzing data associated with the at least one asset from the subset of assets (e.g., non-critical assets). In some embodiments, a candidate asset is an asset that qualifies for optimization based on the result of the analysis of the data associated with the at least one asset. In some embodiments, such data includes operating load data for the asset. The operating load data may comprise a current operating load for the asset with respect to the optimization period. In some embodiments, such candidate assets may be referred to as candidate assets and/or optimization candidates.

In some embodiments, analyzing an asset to determine if the asset qualifies as a candidate asset (e.g., optimization candidate) comprises determining if the asset deviates from an operating load range for the asset based on an operating load data associated with the candidate asset. For example, in some embodiments, the optimization module 114 is configured to compare the current operating load data for an asset to a corresponding operating load range (e.g., corresponding current operating load range) to determine if the asset deviates from the operating load range. In some embodiments, the current operating load data for an asset is the operating load for the asset with respect to an optimization period (e.g., the operating load data for a given optimization period). In some embodiments, the current operating load range for an asset is the operating load range for the asset with respect to an optimization period (e.g., the operating load range for a given optimization period). In some embodiments, the operating load range represents optimal operating load range.

In some embodiments, the operating load range is determined based at least in part on environmental condition for the optimization period. For example, the operating load range may be dynamic and may depend on one or more factors, such as current environmental condition (e.g., season, temperature, humidity, pressure, and/or the like). Alternatively or additionally, the operating load range may depend on the type of asset, the building served by the assets, the spatial region (e.g., space) served by the assets, and/or other asset classification variables. For example, the operating load range for a particular asset may be different for different buildings (e.g., hospitals, commercial buildings, and/or the like) and/or may be different for different seasons of the year.

In some embodiments, operating load data comprises one or more items of data representative and/or indicative of a value of an operating load parameter associated with the asset. For example, the operating load data may comprise a setpoint (e.g., current setpoint) for an operating load parameter such as, for example, temperature setpoint. In this regard, the operating load range correspond to a load setpoint range such as temperature set point range.

In some embodiments, the load optimization module 114 may be configured to communicate with one or more data sources to obtain current environmental condition data for determining the operating load range. In some embodiments, the one or more data sources may comprise internal data source and/or external data sources such as one or more third-party data sources.

In some embodiments, the load optimization module 114 may leverage one or more data sources to determine the operating load range for an asset based on current environmental condition. In some embodiments, the one or more data sources may comprise one or more operating load guidelines (e.g., operating load standards), such as industry guidelines/standards. A non-limiting example of such operating load guidelines is American Society of Heating, Refrigerating and Air-Conditioning Engineers (ASHRAE) standard.

In some embodiments, the load optimization module 114 is configured to apply the operating load data for an asset for a given optimization period (e.g., current operating load for the asset), environmental condition data for the optimization period (e.g., current environmental condition), and one or more operating load guidelines to an optimization machine learning model configured to determine if the asset deviates from the operating load range.

In some embodiments, the load optimization module 114 is configured to, in response to determining that an asset deviates from the operating load range, identify or otherwise select the asset as a candidate asset (e.g., optimization candidate). For example, in some embodiments, the load optimization module 114 is configured to generate deviation data that comprises one or more items of data representative and/or indicative of how much the asset deviates from the operating load range, and identify an asset as a candidate asset in response to and/or based on the deviation data. In some embodiments, load optimization module 114 generates optimization data. In some embodiments, the optimization data may be generated based at least in part on the deviation data. In some embodiments, the optimization data may comprise one or more items of data representative and/or indicative of an adjustment amount for the asset.

In some embodiments, the load optimization module 114 is configured to optimize an asset identified as a candidate asset at least in part by initiating the performance of one or more load optimization-based actions based on the optimization data. In some embodiments, initiating the performance of one or more load optimization-based actions comprises causing the operating load range of the asset to be adjusted or otherwise reconfiguring the asset to correct the deviation such that the operating load range for the asset is within the operating load range. In some embodiments, by maintaining the assets within the corresponding operation condition range, the load optimization module 114 ensures that the load associated with the site is maintained below the predetermined threshold and/or provides predictability with respect to the load for the site. For example, the predetermined threshold may be based on the operating load range for the various assets associated with the site and under the various conditions.

In some embodiments, initiating the performance of the one or more load optimization-based actions and/or causing the operating load range of an asset to be adjusted or reconfiguration of an asset comprises transmitting computer-executable instructions configured to cause the operating load parameter (e.g., load setpoint) and/or other related parameters to be modified to correct the deviation such that the operating load data for the asset is within the operating load range or configured to cause reconfiguration of the asset such that the operating load data for the asset is within the operating load range.

In some embodiments, initiating the performance of the one or more load optimization-based actions comprise providing data that describes the deviation and/or amount of deviation to one or more client computing entities (e.g., client computing devices). In some embodiments, initiating the performance of the one or more load optimization-based actions comprises generating one or more notification, alerts, and/or alarms in response to determining that an asset deviates from the operating load range.

In some embodiments, the optimization module 114 may be configured to adjust an operation parameter outside of the standard operating range if determined that otherwise, the load demand for the site would exceed the predetermined threshold. In this regard, the optimization module 114 may be configured to select from the candidate assets one or more assets whose operating load parameter would be adjusted outside of the corresponding operating load range based on one or more criteria. In some embodiments, the one or more criteria and/or portions thereof may be user-defined and/or configurable. In some embodiments, the one or more criteria comprises spatial region activity type (e.g., activity type in the spatial region served) for spatial region served by an asset, impact (e.g., safety, comfort, and/or the like), purpose served by the asset, and/or the like.

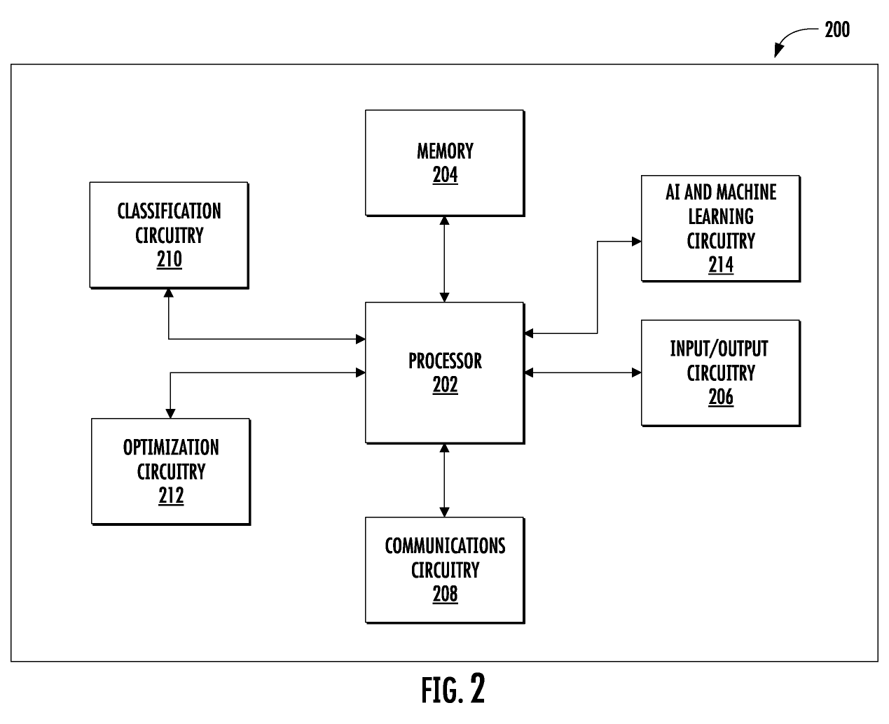

FIG. 2 illustrates a block diagram of an example apparatus that may be specially configured in accordance with at least one example embodiment of the present disclosure. Specifically, FIG. 2 depicts an example load management apparatus 200 (“apparatus 200”) specially configured in accordance with at least some example embodiments of the present disclosure. In some embodiments, the load management system 103 and/or a portion thereof is embodied by one or more system(s), such as the apparatus 200 as depicted and described in FIG. 2. The apparatus 200 includes processor 202, memory 204, input/output circuitry 206, communications circuitry 208, classification circuitry 210, and/or optimization circuitry 212. In some embodiments, the apparatus 200 is configured, using one or more of the sets of circuitry embodied by processor 202, memory 204, input/output circuitry 206, communications circuitry 208, classification circuitry 210, optimization circuitry 212, and/or AI and machine learning circuitry 214 to execute and perform the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the apparatus 200 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the apparatus 200. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the apparatus 200 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed. As one particular example embodiment, the processor 202 is configured to perform various operations associated with performing improved asset monitoring associated with a process control and automation system.

In some embodiments, the apparatus 200 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user.

In some embodiments, the apparatus 200 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from user device, one or more asset(s) or accompanying sensor(s) , and/or other external computing device in communication with the apparatus 200.

In some embodiments, the apparatus 200 includes a classification circuitry 210. The classification circuitry 210 includes hardware, software, firmware, and/or a combination thereof, that supports load optimization for a site. For example, in some embodiments, the classification circuitry 210 includes hardware, software, firmware, and/or a combination thereof, configured to, with the processing circuitry 202, input/output circuitry 206 and/or communications circuitry 208, perform one or more functions associated with the classification module 112. In some embodiments, the classification circuitry 210 includes a separate processor, specially configured field programmable gate array (FPGA), or a specially programmed application specific integrated circuit (ASIC).

In some embodiments, the apparatus 200 includes an optimization circuitry 212. The optimization circuitry 212 includes hardware, software, firmware, and/or a combination thereof, that supports load optimization for a site. For example, in some embodiments, the optimization circuitry 212 includes hardware, software, firmware, and/or a combination thereof, configured to, with the processing circuitry 202, input/output circuitry 206 and/or communications circuitry 208, perform one or more functions associated with the optimization module 114. In some embodiments, the optimization circuitry 212 includes a separate processor, specially configured field programmable gate array (FPGA), or a specially programmed application specific integrated circuit (ASIC).

In some embodiments, the apparatus 200 includes AI and machine learning circuitry 214 In some embodiments, the AI and machine learning circuitry 214 may include hardware, software, firmware, and/or a combination thereof designed and/or configured to request, receive, process, generate, and transmit data, data structures, control signals, and electronic information for training and executing a trained AI and/or machine learning model (AI/ML model) configured to facilitate the operations and/or functionalities described herein. For example, in some embodiments the AI and machine learning circuitry 214 includes hardware, software, firmware, and/or a combination thereof, that identifies training data and/or utilizes such training data for training a particular machine learning model, AI, and/or other model to generate particular output data based at least in part on learnings from the training data. Additionally or alternatively, in some embodiments, the AI and machine learning circuitry 214 includes hardware, software, firmware, and/or a combination thereof, that embodies or retrieves a trained machine learning model, AI and/or other specially configured model utilized to process inputted data. Additionally or alternatively, in some embodiments, the AI and machine learning circuitry 214 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

In some embodiments, two or more of the sets of circuitries 202-214 are combinable. Alternatively or additionally or in some embodiments, one or more of the sets of circuitries embodying processor 202, memory 204, input/output circuitry 206, communications circuitry 208, classification circuitry 210, optimization circuitry 212, and/or AI and machine learning circuitry 214 perform some or all of the functionality described as associated with another component. For example, in some embodiments, two or more of the sets of circuitry embodied by processor 202, memory 204, input/output circuitry 206, communications circuitry 208, classification circuitry 210, optimization circuitry 212, and/or AI and machine learning circuitry 214 are combined into a single module embodied in hardware, software, firmware, and/or a combination thereof. Similarly, in some embodiments, one or more of the sets of circuitry, for example classification circuitry 210, optimization circuitry 212, and/or AI and machine learning circuitry 214 is/are combined with the processor 202, such that the processor 202 performs one or more of the operations described above with respect to each of these sets of circuitry embodied by the classification circuitry 210, optimization circuitry 212, and/or AI and machine learning circuitry 214.

Example embodiments of the present disclosure provide load management techniques configured to maintain the energy demand for a site by selecting one or more assets from a set of assets associated with a site for optimization based on dynamic classification of the set of assets, and optimizing the load (e.g., corresponding to energy consumption) associated with the site by analyzing the selected assets and adjusting the operating load parameter(s) for one or more of the selected assets.

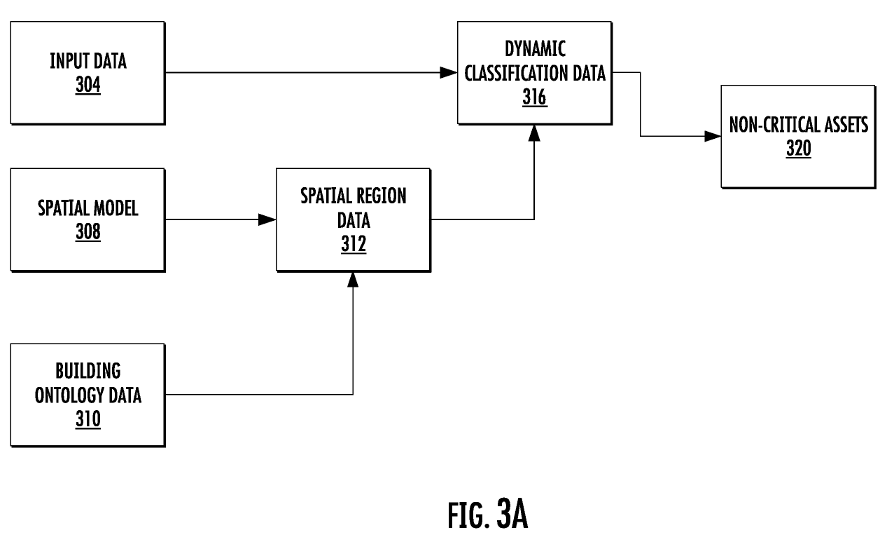

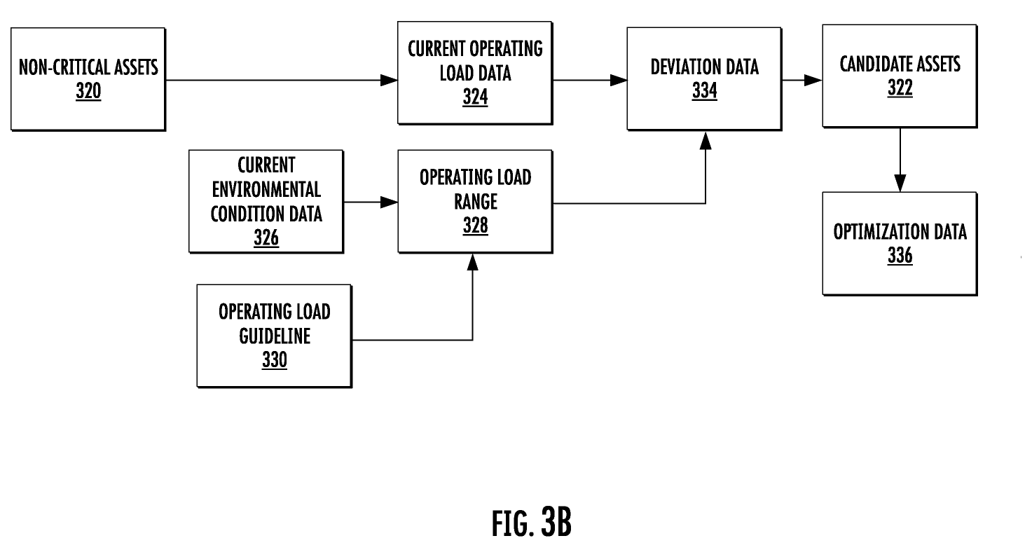

FIG. 3A is a data flow diagram showing example data structures for classifying assets for optimization in accordance with at least one example embodiment of the present disclosure.

In some embodiments, the load management system 103 identifies input data 304 associated with a set of assets associated with a site. In some embodiments, the load management system 103 may identify the set of assets from building data received from the load management system 103 (e.g., during onboarding). In some embodiments, the building data comprises one or more items of data representative and/or indicative of identifying data (e.g., asset identifier) for the set of assets, type of asset of each asset in the set of assets, initial classification for each asset of the set of assets and/or other data about and/or related to the set of assets.

In some embodiments, the input data comprises asset classification variables. In some embodiments, an asset classification variable comprise environmental condition, such as temperature, humidity, and/or the like; occupancy (e.g., expected traffic or actual traffic in a spatial region served by an asset such as, for example, number of people occupying a spatial region or moving in and out of a spatial region); temporal feature (e.g., time of the day, season, and/or the like), activity (e.g., designated activity in a spatial region served by an asset), item type (e.g., types of items in a spatial region served by an asset), and/or asset type.

In some embodiments, the load management system 103 (e.g., via the asset classification module 112) applies the input data (e.g., asset classification variables data) for the given optimization period to an asset classification machine learning model configured to assess and/or analyze the asset classification variables data with respect to each asset of the set of assets (or portion thereof) and classify the assets as critical or non-critical based on the analysis. In this regard, in some embodiments, the load management system 103 (e.g., via the asset classification module 112) may be configured to generate classification data 316 for the set of asset based at least in part on the asset classification variables, wherein the classification data 316 comprises a dynamic classification for each of the assets in the sets of assets. In some embodiments, applying the input data to the asset classification machine learning model comprises inputting the input data into the asset classification machine learning model and obtaining the output (e.g., classification data for the set of assets) of the asset classification machine learning model. In some embodiments, the load management system, using the asset classification machine learning model, may be configured to traverse the building data (e.g.., comprising asset identifiers corresponding to the set of assets) periodically and classify the set of assets.

In some embodiments, the asset classification machine learning model is a data entity that describes parameters, hyper-parameters, and/or defined operations of a rules-based algorithm, machine learning model (e.g., model including at least one or more rule-based layers, one or more layers that depend on trained parameters, coefficients, and/or the like), and/or artificial intelligence model, and/or the like. An asset classification machine learning model may include any type of model configured, trained, and/or the like to perform classification task on input data, such as asset classification variable data, to classify as asset as a critical asset or non-critical asset with respect to a particular optimization period. In this regard, an asset classification machine learning model may be configured to utilize one or more of any types of machine learning, rules-based, and/or artificial intelligence techniques including one or more of, supervised learning (e.g., using user feedback), unsupervised learning, semi-supervised learning, reinforcement learning, computer vision techniques, sequence modeling techniques, language processing techniques, neural network techniques, and/or generative artificial intelligence techniques. In some embodiments, the asset classification machine learning model is a component of a composite load optimization machine learning model.

In some embodiments, a composite load optimization machine learning model is a machine learning model (e.g., a data entity that describes parameters, hyper-parameters, and/or defined operations of a rules-based algorithm, machine learning model (e.g., model including at least one or more rule-based layers, one or more layers that depend on trained parameters, coefficients, and/or the like), and/or artificial intelligence model, and/or the like) that includes two or more machine learning models representing components of the composite load optimization machine learning model. In some embodiments, a composite load optimization machine learning model includes one or more of asset classification machine learning model, spatial region classification machine learning model, and/or optimization machine learning model.

In some embodiments, the load management system 103 receives spatial model 308 associated with a building. In some embodiments, the load management system 103 receives the spatial via one or more client computing entities associated with the site. In some embodiments, a spatial model 308 is configured to define spatial regions associated with a building, where a spatial region describes a particular area or space within a building or the vicinity of building. Non-limiting examples of a spatial region includes bathroom, parking area, parking corridor, data center room, server room, cafeteria, physician office, and/or other spaces within and/or associated with a building. In some embodiments, a space model may comprise a representation of a layout of a building.

In some embodiments, the load management system 103 (e.g., via the asset classification module 112) generates spatial region data 312 for the set of assets by performing analytics on the spatial model received. In some embodiments, the load management system 103 (e.g., via the asset classification module 112) is configured to apply the spatial model to a spatial region classification machine learning model configured to perform analytics on the spatial model to extract spatial region information from the spatial model and generate spatial region data as described herein.

In some embodiments, the load management system 103 (e.g., via the asset classification module 112) leverages building ontology data 310 to generate spatial region data. In some embodiments, building ontology data comprises one or more items of data representative and/or indicative of a building taxonomy for various building types. For example, in some embodiments, building ontology data may comprise one or more items data that describes the spatial regions (e.g., spaces) associated with various types of buildings (e.g., industrial building, retail building, office building, and/or the like) and subcategories.

In some embodiments, the load management system 103 (e.g., via the asset classification module 112) applies the spatial model 308 and the building ontology data 310 to a spatial region classification machine learning model. For example, the load management system 103 (e.g., via the asset classification module 112) may provide the spatial model 308 and building ontology data 310 as input to a spatial region classification machine learning model configured to perform analytics on the spatial model, and using information from the building ontology data 310, to extract spatial region information (e.g., space information) for the building whose spatial model is input into the spatial region classification machine learning model. In some embodiments, the spatial region data output by the spatial region classification machine learning model comprises one or more items of data that describes spatial regions associated with a building and/or the relationship between the spatial regions.

Alternatively or additionally, in some embodiments, the spatial region data output by the spatial region classification machine learning model comprises spatial region classifications for the identified spatial regions. For example, in some embodiments, the spatial region data may comprise one or more items of data representative and/or indicative of a classification for a spatial region. For example, each spatial region may be classified as either critical or non-critical. In some embodiments, the spatial region classifications may be dynamic in that classification for a given spatial region may vary based on the time of day, season, and/or other variables.

Alternatively or additionally, in some embodiments, the spatial region data comprises one or more spatial region groups, where each spatial region group is associated with a spatial region group classification. In some embodiments, the one or more spatial region groups comprise at least one spatial region group associated with a critical classification and at least one spatial region group associated with a non-critical classification. In some embodiments, the spatial regions groups may comprise a plurality of spatial region group sets, each spatial region group set comprising at least one spatial region group associated with a critical classification and at least one spatial region group associated with a non-critical classification. In some embodiments, each spatial region group set may be associated with a time interval and/or condition as described above.

Alternatively or additionally, in some embodiments, the identified spatial regions are ranked in order based on a critical level assigned or otherwise associated with the spatial regions. For example, the spatial region data may comprise data representative and/or indicative of an ordered list of spatial regions associated with a building based on a critical level assigned or otherwise associated with the spatial regions. A non-limiting example of an ordered list of assets may comprise [data centers → work areas → washrooms → cafeteria → staircases → parking]. In the example ordered list, data centers may be associated with a higher critical level relative to work areas, whereas work area is associated with a higher critical level relative to staircases, and

Additionally, in some embodiments, the ordered list may be dynamic in that the order may depend on certain variables which may include the asset classification variables described above (or portion thereof). For example, in some embodiments, the spatial region data may comprise a plurality of ordered lists of spatial regions each associated with a particular time interval and/or condition.

In some embodiments, the spatial region classification machine learning model is a data entity that describes parameters, hyper-parameters, and/or defined operations of a rules-based algorithm, machine learning model (e.g., model including at least one or more rule-based layers, one or more layers that depend on trained parameters, coefficients, and/or the like), and/or artificial intelligence model, and/or the like. A spatial region classification machine learning model may include any type of model configured, trained, and/or the like to perform classification task on input data, such as asset classification variable data, to classify a spatial region as a critical or non-critical (which may be with respect to a particular optimization period). In this regard, a spatial region classification machine learning model may be configured to utilize one or more of any types of machine learning, rules-based, and/or artificial intelligence techniques including one or more of, supervised learning (e.g., using user feedback), unsupervised learning, semi-supervised learning, reinforcement learning, computer vision techniques, sequence modeling techniques, language processing techniques, neural network techniques, and/or generative artificial intelligence techniques. In some embodiments, the spatial region classification machine learning model is a component of a composite load optimization machine learning model.

In some embodiments, the load management system 103 (e.g., via the asset classification module 112) is configured to leverage the spatial region data to classify an asset as critical or non-critical. For example, the load management system 103 (e.g., via the asset classification module 112) may leverage the spatial region data to generate the dynamic classification data 316 for the set of assets. For example, load management system 103 (e.g., via the asset classification module 112) may be configured to identify the spatial region which an asset serves and classify the asset based on the classification and/or critical level for the identified spatial region for the given optimization period.

In some embodiments, the load management system 103 (e.g., via the asset classification module 112) selects the non-critical assets 320 from the set of assets. The non-critical assets 320 may comprise a subset of the set of assets classified as non-critical for the current optimization period.

FIG. 3B is a data flow diagram showing example data structures for load optimization in accordance with at least one example embodiment of the present disclosure.

In some embodiments, the load management system 103 (e.g., via the load optimization module 114), for a given optimization period, identifies one or more candidate assets 322 for optimization from assets classified as non-critical by the classification module 112 (e.g., non-critical assets 320).

In some embodiments, the load management system 103 (e.g., via the load optimization module 114), for a given optimization period, identifies one or more candidate assets 322 by analyzing data associated with the at least one asset from the non-critical assets 320. In some embodiments, a candidate asset is an asset that qualifies for optimization based on the result of the analysis of the data associated with the asset. In some embodiments, such data includes operating load data for the asset. The operating load data may comprise a current operating load for the asset with respect to the optimization period. For example, operating load data may comprise one or more items of data representative and/or indicative of a value of an operating load parameter associated with the asset. For example, the operating load data may comprise a setpoint (e.g., current setpoint) for an operating load parameter such as, for example, temperature setpoint. In this regard, the operating load range correspond to a load setpoint range such as temperature set point range.

In some embodiments, the load management system 103 (e.g., via the load optimization module 114) identifies current operating load data 324 for a non-critical asset 320. In some embodiments, analyzing a non-critical asset 320, to determine if the asset qualifies as a candidate asset 322 (e.g., optimization candidate) comprises determining if the non-critical asset 320 deviates from an operating load range for the non-critical 320 asset based on an operating load data 324 associated with the non-critical asset 320. For example, in some embodiments, the load management system 103 (e.g., via the load optimization module 114) compares the current operating load data 324 for a non-critical asset 320 to a corresponding operating load range 328 to determine if the non-critical asset 320 deviates from the operating load range 328. In some embodiments, identifying current operating load data 324 for a non-critical asset 320 comprises receiving the current operating load data 324 from the non-critical asset 320 and/or building system associated with the assets. In some embodiments, identifying the operating load data 324 comprises receiving telemetry data from the non-critical asset 320 and/or the building system associated with the non-critical asset 320.

In some embodiments, the operating load range 328 is determined based at least in part on environmental condition for the optimization period. For example, the operating load range may be dynamic and may depend on one or more factors, such as current environmental condition (e.g., season, temperature, humidity, pressure, and/or the like). Alternatively or additionally, the operating load range may depend on the type of asset, the building served by the assets, the spatial region (e.g., space) served by the assets, and/or other dynamic energy consumption variables. For example, the operating load range for a particular asset may be different for different buildings (e.g., hospitals, commercial buildings, and/or the like) and/or may be different for different seasons of the year.

In some embodiments, the load management system 103 (e.g., via the load optimization module 114) identifies the environmental condition data 326 from one or more data sources. For example, the load management system 103 (e.g., via the load optimization module 114) may communicate with one or more data sources to obtain current environmental condition data 326 for determining the operating load range 328. In some embodiments, the one or more data sources may comprise internal data source and/or external data sources such as one or more third-party data sources.

In some embodiments, the load management system 103 (e.g., via the load optimization module 114) determines the operating load range 328 based on the current environmental condition data 326 and one or more operating load guidelines 330. In some embodiments, the load optimization module 114 may leverage one or more data sources to determine the operating load range for an asset based on current environmental condition. In some embodiments, the one or more data sources may comprise one or more operating load guidelines (e.g., operating load standards), such as industry guidelines/standards. A non-limiting example of such operating load guidelines is ASHRAE standard.

In some embodiments, the load management system 103 (e.g., via the load optimization module 114) applies the operating load data 324 for an asset for a given optimization period (e.g., current operating load data 324 for the non-critical asset 320), environmental condition data 326 for the optimization period (e.g., current environmental condition data 326), and one or more operating load guidelines to an optimization machine learning model configured to determine if the asset deviates from the operating load range. In this regard, in some embodiments, the load management system 103 applies a dataset comprising current operating load data for at least one asset and current environmental condition data to an optimization machine learning model to determine if the asset deviates from current operating load range with respect to the optimization period (e.g., current operating load range for the asset for the optimization period).

In some embodiments, the optimization machine learning model is a data entity that describes parameters, hyper-parameters, and/or defined operations of a rules-based algorithm, machine learning model (e.g., model including at least one or more rule-based layers, one or more layers that depend on trained parameters, coefficients, and/or the like), and/or artificial intelligence model, and/or the like. An optimization machine learning model may include any type of model configured, trained, and/or the like to perform optimization on a dataset, to generate optimization data. In this regard, an asset classification machine learning model may be configured to utilize one or more of any types of machine learning, rules-based, and/or artificial intelligence techniques including one or more of, supervised learning (e.g., using user feedback), unsupervised learning, semi-supervised learning, reinforcement learning, computer vision techniques, sequence modeling techniques, language processing techniques, neural network techniques, and/or generative artificial intelligence techniques. In some embodiments, the optimization machine learning model is a component of a composite load optimization machine learning model.

In some embodiments, the load management system 103 (e.g., via the load optimization module 114), in response to determining that a non-critical asset deviates from the operating load range 328, identifies or otherwise selects the non-critical asset 320 as a candidate asset 322 (e.g., optimization candidate). For example, in some embodiments, the load management system 103 (e.g., via the load optimization module 114), generates deviation data 334 comprising one or more items of data representative and/or indicative of how much the asset deviates from the operating load range, and identifies an asset as a candidate asset 322 in response to and/or based on the deviation data 334. In some embodiments, the load management system 103 (e.g., via the load optimization module 114), generates optimization data 336 for candidate asset(s) 322. In some embodiments, the optimization data 336 may be generated based at least in part on the deviation data 334. In some embodiments, the optimization data 336 may comprise one or more items of data representative and/or indicative of an adjustment amount for the non-critical asset 320.

In some embodiments, the load management system 103 (e.g., via the load optimization module 114) optimizes an asset identified as a candidate asset 322 at least in part by initiating the performance of one or more load optimization-based actions. In some embodiments, initiating the performance of one or more load optimization-based actions comprises determining adjustment data. In some embodiments, adjustment data may comprise one or more items of representative and/or indicative of how much adjustment/modification to make to the operating load for the asset.

In some embodiments, as described above, the load optimization module 114 is configured to optimize an asset identified as a candidate asset 322 at least in part by initiating the performance of one or more load optimization-based actions. In some embodiments, initiating the performance of one or more load optimization-based actions comprises causing the operating load data 324 of the asset to be adjusted or otherwise reconfiguring the non-critical asset to correct the deviation such that the operating load data 324 for the asset is within the operating load range 328. In some embodiments, by maintaining the assets within the corresponding operating load range, the load optimization module 114 ensures that the load associated with the site is maintained below the predetermined threshold and/or provides predictability with respect to the load for the site. For example, the predetermined threshold may be based on the operating load range for the various assets associated with the site and under the various conditions.

In some embodiments, initiating the performance of the one or more load optimization-based actions and/or causing the operating load range of an asset to be adjusted or reconfiguring of an asset comprises transmitting computer-executable instructions configured to cause the operating load parameter (e.g., load setpoint) and/or other related parameters to be modified to correct the deviation such that the operating load data for the asset is within the operating load range and/or configured to cause reconfiguration of the asset such that the operating load data for the asset is within the operating load range.

In some embodiments, initiating the performance of the one or more load optimization-based actions comprise providing data that describes the deviation and/or amount of deviation to one or more client computing entities (e.g., client computing devices). In some embodiments, initiating the performance of the one or more load optimization-based actions comprises generating one or more notification, alerts, and/or alarms in response to determining that an asset deviates from the operating load range 328.

In some embodiments, the optimization module 114 may be configured to adjust an operation parameter outside of the standard operating range if determined that otherwise, the load demand for the site would exceed the predetermined threshold. In this regard, the optimization module 114 may be configured to select from the candidate assets 322 one or more assets whose operating load parameter would be adjusted outside of the corresponding operating load range based on one or more criteria. In some embodiments, the one or more criteria and/or portions thereof may be user-defined and/or configurable. In some embodiments, the one or more criteria comprises spatial region activity type (e.g., activity type in the spatial region served) for spatial region served by an asset, impact (e.g., safety, comfort, and/or the like), purpose served by the asset, and/or the like.

### EXAMPLE PROCESSES OF THE DISCLOSURE

Having described example systems and apparatuses, and data visualizations in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

Although the example processes depict a particular sequence of operations, the sequence may be altered without departing from the scope of the present disclosure. For example, some of the operations depicted may be performed in parallel or in a different sequence that does not materially affect the function of the processes.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

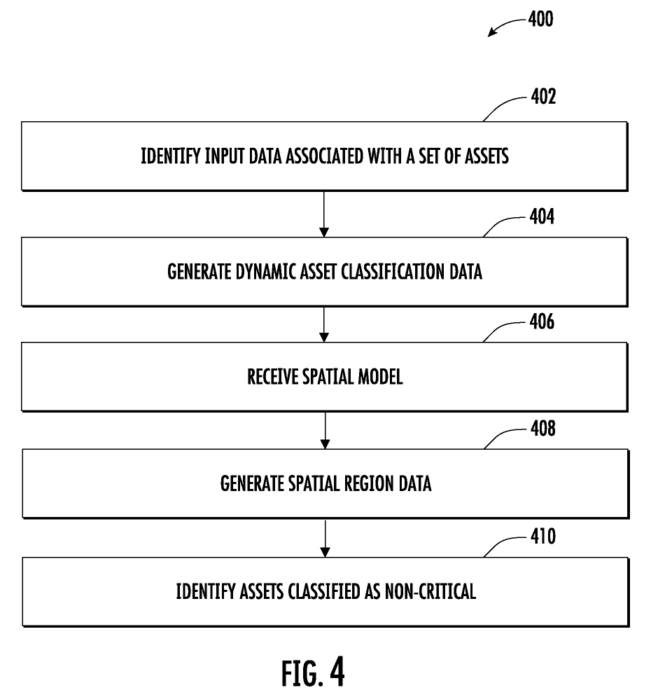

FIG. 4 illustrates a flowchart including operations of an example process/method for asset classification for optimization in accordance with at least one example embodiment of the present disclosure. In some embodiments, the process/method 400 is embodied by computer program code stored on a non-transitory computer-readable storage medium of a computer program product configured for execution to perform the process as depicted and described. Alternatively or additionally, in some embodiments, the process/method 400 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with separate component(s) of a network, external network(s), and/or the like, to perform one or more of the operation(s) as depicted and described. For purposes of simplifying the description, the process/method 400 is described as performed by and from the perspective of the apparatus 200.

Although the example process/method 400 depicts a particular sequence of operations, the sequence may be altered without departing from the scope of the present disclosure. For example, some of the operations depicted may be performed in parallel or in a different sequence that does not materially affect the function of the process/method 400. In other examples, different components of an example device or system that implements the process/method 400 may perform functions at substantially the same time or in a specific sequence.

According to some examples, the process/method 400 includes at operation 402, identifying input data associated with a set of assets associated with a site. For example, the apparatus 200 may identify input data for a set of assets associated with one or more buildings associated with a site. In some embodiments, the input data comprises asset classification variables. In some embodiments, an asset classification variable comprise environmental condition, such as temperature, humidity, and/or the like; occupancy (e.g., expected traffic or actual traffic in a spatial region served by an asset such as, for example, number of people occupying a spatial region or moving in and out of a spatial region); temporal feature (e.g., time of the day, season, and/or the like), activity (e.g., designated activity in a spatial region served by an asset), item type (e.g., types of items in a spatial region served by an asset), and/or asset type.

According to some example, the process/method 400 includes, at operation 404, generating classification data for the set assets. For example, the apparatus 200 may generate dynamic classification data for the set of assets. In some embodiments, the apparatus 200 applies the input data for a given optimization period to an asset classification machine learning model configured to assess and/or analyze the asset classification variables data with respect to each asset of the set of assets (or portion thereof) and classify the assets as critical or non-critical based on the analysis. For example, the classification machine learning model may be configured to perform classification operation task on the input data to generate the classification data for the set of assets. In this regard, in some embodiments, the apparatus 200 may generate the dynamic classification data for the set of assets based at least in part on the asset classification variables, wherein the classification data comprises a dynamic classification for each of the assets in the sets of assets.

In some embodiments, applying the input data to the asset classification machine learning model comprises inputting the input data into the asset classification machine learning model and obtaining the output (e.g., classification data for the set of assets) of the asset classification machine learning model. In some embodiments, the apparatus 200, using the asset classification machine learning model, may be configured to traverse building data (e.g.., comprising asset identifiers corresponding to the set of assets) periodically and classify the set of assets. In this regard, in some embodiments, the input data includes building data, as described above.

According to some examples, the process/method 400 includes, at operation 406, receiving spatial model associated with a building. For example, the apparatus 200 may receive spatial model associated with a building associated with a site.

According to some examples, the process/method 400 includes, at operation 408, generating spatial region data. For example, the apparatus 200 may generate spatial region data for the set of assets by performing analytics on the spatial model received. In some embodiments, the apparatus may apply the spatial model to a spatial region classification machine learning model configured to perform analytics on the spatial model to extract spatial region information from the spatial model and generate spatial region data as described herein. In some embodiments, apparatus 200 leverages building ontology data to generate spatial region data.

In some embodiments, the apparatus 200 applies the spatial model and the building ontology data to a spatial region classification machine learning model. For example, the apparatus 200 may provide the spatial model and building ontology data as input to a spatial region classification machine learning model configured to perform analytics on the spatial model, and using information from the building ontology data, to extract spatial region information (e.g., space information) for the building whose spatial model is input into the spatial region classification machine learning model.

In some embodiments, the apparatus 200 may leverage the spatial region data to classify an asset as critical or non-critical. For example, the classification For example, the load management system 103 (e.g., via the asset classification module 112) may leverage the spatial region data to generate the dynamic classification data for the set of assets. For example, the apparatus 200 may be configured to identify the spatial region which an asset serves and classify the asset based on the classification and/or critical level for the identified spatial region for the given optimization period.

According to some example, the process/method 400 included at operation 410, identifying assets classified as non-critical assets and/or generating data that describes assets classified as non-critical assets. For example, the apparatus 200 may identify assets classified as non-critical assets and/or generate data that describes assets classified as non-critical assets.

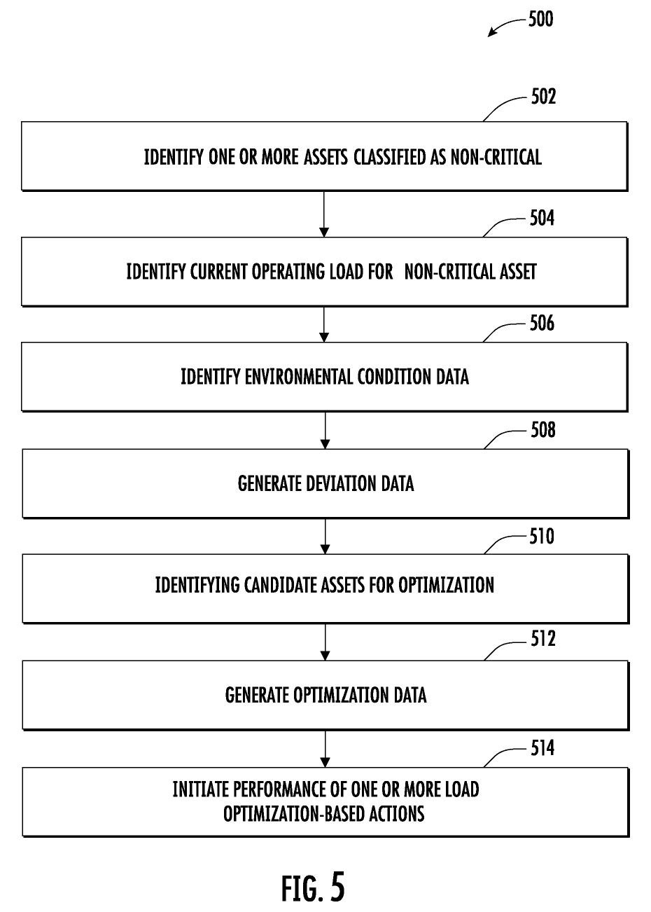

FIG. 5 illustrates a flowchart including operations of an example process/method for load optimization in accordance with at least one example embodiment of the present disclosure. In some embodiments, the process/method 500 is embodied by computer program code stored on a non-transitory computer-readable storage medium of a computer program product configured for execution to perform the process as depicted and described. Alternatively or additionally, in some embodiments, the process/method 500 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with separate component(s) of a network, external network(s), and/or the like, to perform one or more of the operation(s) as depicted and described. For purposes of simplifying the description, the process/method 500 is described as performed by and from the perspective of the apparatus 200.

Although the example process/method 500 depicts a particular sequence of operations, the sequence may be altered without departing from the scope of the present disclosure. For example, some of the operations depicted may be performed in parallel or in a different sequence that does not materially affect the function of the process/method 500. In other examples, different components of an example device or system that implements the process/method 500 may perform functions at substantially the same time or in a specific sequence.

According to some examples, the process/method 500 includes at operation 502, for an optimization period, identifying one or more assets from assets classified as non-critical (e.g., by process/method 400). Such assets may be referred to as non-critical assets for the optimization period. As further described below, the apparatus 200 may be configured to identify one or more candidate assets by analyzing data associated with at least one asset from the one or more non-critical assets.

According to some examples, the process/method 500 includes at operation 504, identifying current operating load data for a non-critical asset. For example, the apparatus 200 may identify current operating load data for a non-critical asset. The operating load data may comprise a current operating load for the non-critical asset with respect to the optimization period. For example, operating load data may comprise one or more items of data representative and/or indicative of a value of an operating load parameter associated with the non-critical asset. For example, the operating load data may comprise a setpoint (e.g., current setpoint) for an operating load parameter such as, for example, temperature setpoint. In this regard, the operating load range correspond to a load setpoint range such as temperature set point range.

In some embodiments, analyzing a non-critical asset to determine if the asset qualifies as a candidate asset comprises determining if the asset deviates from an operating load range for the non-critical asset based on the current operating load data associated with the non-critical asset. For example, in some embodiments, the apparatus 200 compares the current operating load data for a non-critical asset to a corresponding operating load range to determine if the non-critical asset deviates from the operating load range. In some embodiments, identifying current operating load data for a non-critical asset comprises receiving the current operating load data from the non-critical asset and/or building system associated with the non-critical asset. In some embodiments, identifying the current operating load data comprises receiving telemetry data from the non-critical asset and/or the building system associated with the non-critical asset.

In some embodiments, the operating load range is determined based at least in part on environmental condition for the optimization period. For example, the operating load range may be dynamic and may depend on one or more factors, such as current environmental condition (e.g., season, temperature, humidity, pressure, and/or the like). Alternatively or additionally, the operating load range may depend on the type of the non-critical asset, the building served by the non-critical assets, the spatial region (e.g., space) served by the non-critical asset, and/or other dynamic energy consumption variables. For example, the operating load range for a particular non-critical asset may be different for different buildings (e.g., hospitals, commercial buildings, and/or the like) and/or may be different for different seasons of the year.

According to some examples, the process/method 500 includes at operation 506, identifying environmental condition data from one or more data sources. For example, apparatus 200 may communicate with one or more data sources to obtain current environmental condition data for determining the operating load range. In some embodiments, the one or more data sources may comprise internal data source and/or external data sources such as one or more third-party data sources.

In some embodiments, the apparatus 200 determines the operating load range based on the current environmental data and one or more operating load guidelines. In some embodiments, the apparatus may leverage one or more data sources to determine the operating load range for an asset based on current environmental condition. In some embodiments, the one or more data sources may comprise one or more operating load guidelines (e.g., operating load standards), such as industry guidelines/standards. A non-limiting example of such operating load guidelines is ASHRAE standard.

According to some examples, the process/method 500 includes, at operation 508, generating deviation data for the non-critical asset. For example, the apparatus 200 may apply the operating load data for a non-critical asset for a given optimization period (e.g., current operating load for the asset), environmental condition data for the optimization period (e.g., current environmental condition), and one or more operating load guidelines to an optimization machine learning model configured to generate deviation data for the set of assets. The deviation data for a non-critical asset may comprise one or more items of data representative and/or indicative of how much the non-critical asset deviates from the corresponding operating load range.

According to some examples, the process/method 500 includes, at operation 510, in response to determining that a non-critical asset deviates from the operating load range, identifying or otherwise selecting the non-critical asset as a candidate asset (e.g., optimization candidate). For example, in some embodiments, the apparatus 200 analyzes the deviation data, and identifies a non-critical asset as a candidate asset in response to and/or based on the deviation data. In some embodiments, a candidate asset is an asset that qualifies for optimization based on the result of the analysis of the data associated with the at least one asset. In some embodiments, such data includes operating load data for the asset. In this regard, in some embodiments, analyzing a non-critical asset to determine if the asset qualifies as a candidate asset comprises determining if the asset deviates from an operating load range for the non-critical asset based on the current operating load data associated with the non-critical asset (e.g., where the deviation data indicates that the current operating load for the non-critical asset deviates from the current operating load range for the non-critical asset, such that there is opportunity for optimization). For example, in some embodiments, the apparatus 200 compares the current operating load data for a non-critical asset to a corresponding operating load range to determine if the non-critical asset deviates from the operating load range.

According to some examples, the process/method 500 includes, at operation 512, generating optimization data for an asset identified as a candidate asset. For example, the apparatus 200 may generate optimization data for a candidate asset based on the deviation data for the candidate asset. In some embodiments, the optimization data may comprise one or more items of data representative and/or indicative of an adjustment amount for the candidate asset.

According to some examples, the process/method 500 includes, at operation 514, optimizing an asset identified as a candidate asset at least in part by initiating the performance of one or more load optimization-based actions. In some embodiments, initiating the performance of one or more load optimization-based actions comprises determining adjustment data. In some embodiments, adjustment data may comprise one or more items of representative and/or indicative of how much adjustment/modification to make to the operating load for the candidate asset.

In some embodiments, the load optimization module 114 is configured to optimize an asset identified as a candidate asset at least in part by initiating the performance of one or more load optimization-based actions. In some embodiments, initiating the performance of one or more load optimization-based actions comprises causing the operating load range of the candidate asset to be adjusted or otherwise reconfiguring the candidate asset to correct the deviation such that the operating load range for the candidate asset is within the operating load range. In some embodiments, by maintaining the assets within the corresponding operation condition range, example embodiments ensure that the load associated with the site is maintained below the predetermined threshold and/or provides predictability with respect to the load for the site. For example, the predetermined threshold may be based on the operating load range for the various assets associated with the site and under the various conditions.

In some embodiments, initiating the performance of the one or more load optimization-based actions such as causing the operating load range of a candidate asset to be adjusted or reconfiguring of a candidate asset comprises transmitting computer-executable instructions configured to cause the operating load parameter (e.g., load setpoint) and/or other related parameters to be modified to correct the deviation such that the operating load data for the candidate asset is within the operating load range or configured to cause reconfiguration of the candidate asset such that the operating load data for the candidate asset is within the operating load range.

In some embodiments, initiating the performance of the one or more load optimization-based actions comprise providing data that describes the deviation and/or amount of deviation to one or more client computing entities (e.g., client computing devices). In some embodiments, initiating the performance of the one or more load optimization-based actions comprises generating one or more notification, alerts, and/or alarms in response to determining that a candidate asset deviates from the operating load range.

In some embodiments, the apparatus 200 may be configured to adjust an operating load parameter outside of the operating load range (e.g., standard operating range) if determined that otherwise, the load demand for the site would exceed the predetermined threshold. In this regard, the optimization module 114 may be configured to select from the candidate assets one or more assets whose current operating load would be adjusted outside of the corresponding operating load range based on one or more criteria. In some embodiments, the one or more criteria and/or portions thereof may be user-defined and/or configurable. In some embodiments, the one or more criteria comprises spatial region activity type (e.g., activity type in the spatial region served) for spatial region served by an asset, impact (e.g., safety, comfort, and/or the like), purpose served by the candidate asset, and/or the like.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
identifying, by one or more processors, at least one asset of a set of assets associated with a building;
generating, by the one or more processors, dynamic asset classification for the at least one asset for an optimization period by applying input data associated with the at least one asset to an asset classification machine learning model configured to perform classification operation task on the input data, wherein the input data comprises one or more asset classification variables;
generating, by the one or more processors, in response to a non-critical classification for the at least one asset, deviation data for the at least one asset by applying a dataset comprising current operating load data for the at least one asset and current environmental condition data to an optimization machine learning model configured to compare the current operating load data for the at least one asset to operating load range for the at least one asset;
generating, by the one or more processors, optimization data for the at least one asset based on the deviation data; and
initiating, by the one or more processors, performance of one or more load optimization-based actions based on the optimization data.

2. The computer-implemented method of claim 1, wherein the dataset further comprises one or more operating load guidelines, wherein the operating load range for the at least one asset is determined based on the current environmental condition data.

3. The computer-implemented method of claim 2, wherein the at least one asset is associated with a spatial region of one or more spatial regions associated with the building, wherein the operating load range is further determined based on spatial region type of the spatial region associated with the at least one asset.

4. The computer-implemented method of claim 1, further comprising:
receiving a spatial model associated with the building; and
generating spatial region data for the spatial model by applying the spatial model and building ontology data to a spatial region classification machine learning model configured to perform analytics on the spatial model using the building ontology data.

5. The computer-implemented method of claim 1, wherein the one or more asset classification variables comprise one or more of environmental condition, spatial region occupancy, or spatial region activity.

6. The computer-implemented method of claim 1, wherein the current operating load data comprises temperature set point.

7. The computer-implemented method of claim 1, wherein initiating the performance of the one or more optimization-based actions comprises:
transmitting computer-executable instructions configured to cause modification of one or more parameters of the asset such that the current operating load data is within the operating load range.

8. An apparatus comprising at least one processor and at least one memory storing instructions that, when executed by the at least one processor, cause the apparatus to:
identify at least one asset of a set of assets associated with a building;
generate dynamic asset classification for the at least one asset for an optimization period by applying input data associated with the at least one asset to an asset classification machine learning model configured to perform classification operation task on the input data, wherein the input data comprises one or more asset classification variables;
generate, in response to a non-critical classification for the at least one asset, deviation data for the at least one asset by applying a dataset comprising current operating load data for the at least one asset and current environmental condition data to an optimization machine learning model configured to compare the current operating load data for the at least one asset to operating load range for the at least one asset;
generate optimization data for the at least one asset based on the deviation data; and
initiate performance of one or more load optimization-based actions based on the optimization data.

9. The apparatus of claim 8, wherein the dataset further comprises one or more operating load guidelines, wherein the operating load range for the at least one asset is determined based on the current environmental condition data.

10. The apparatus of claim 9, wherein the at least one asset is associated with a spatial region of one or more spatial regions associated with the building, wherein the operating load range is further determined based on spatial region type of the spatial region associated with the at least one asset.

11. The apparatus of claim 8, wherein the at least one memory storing instructions that, when executed by the at least one processor, further cause the apparatus to:
receive a spatial model associated with the building; and
generate spatial region data for the spatial model by applying the spatial model and building ontology data to a spatial region classification machine learning model configured to perform analytics on the spatial model using the building ontology data.

12. The apparatus of claim 8, wherein the one or more asset classification variables comprise one or more of environmental condition, spatial region occupancy, or spatial region activity.

13. The apparatus of claim 8, wherein the current operating load data comprises temperature set point.

14. The apparatus of claim 8, wherein initiating the performance of the one or more optimization-based actions comprises:
transmitting computer-executable instructions configured to cause modification of one or more parameters of the asset such that the current operating load data is within the operating load range.

15. At least one non-transitory computer-readable storage medium having computer coded instructions configured to, when executed by at least one processor:
identify at least one asset of a set of assets associated with a building;
generate dynamic asset classification for the at least one asset for an optimization period by applying input data associated with the at least one asset to an asset classification machine learning model configured to perform classification operation task on the input data, wherein the input data comprises one or more asset classification variables;
generate, in response to a non-critical classification for the at least one asset, deviation data for the at least one asset by applying a dataset comprising current operating load data for the at least one asset and current environmental condition data to an optimization machine learning model configured to compare the current operating load data for the at least one asset to operating load range for the at least one asset;
generate optimization data for the at least one asset based on the deviation data; and
initiate performance of one or more load optimization-based actions based on the optimization data.

16. The at least one non-transitory computer-readable storage medium of claim 15, wherein the dataset further comprises one or more operating load guidelines, wherein the operating load range for the at least one asset is determined based on the current environmental condition data.

17. The at least one non-transitory computer-readable storage medium of claim 16, wherein the at least one asset is associated with a spatial region of one or more spatial regions associated with the building, wherein the operating load range is further determined based on spatial region type of the spatial region associated with the at least one asset.

18. The at least one non-transitory computer-readable storage medium of claim 16, wherein the computer coded instructions further configured to, when executed by the at least one processor:
receive a spatial model associated with the building; and
generate spatial region data for the spatial model by applying the spatial model and building ontology data to a spatial region classification machine learning model configured to perform analytics on the spatial model using the building ontology data.

19. The at least one non-transitory computer-readable storage medium of claim 15, wherein the one or more asset classification variables comprise one or more of environmental condition, spatial region occupancy, or spatial region activity.

20. The at least one non-transitory computer-readable storage medium of claim 15, wherein the current operating load data comprises temperature set point.
